(19) United States
(12) Patent Application Publication
(10) Pub. No.: US 2005/0284894 A1
(43) Pub. Date: Dec. 29, 2005

(54) Dispensers

(76) Inventors: Michael Charles Hore, Buckinghamshire (GB); Christopher Hartley, Buckinghamshire (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/518,671

(22) PCT Filed: Jun. 20, 2003
(86) PCT No.: PCT/GB03/02699

§ 371 Date: Feb. 17, 2005

(30) Foreign Application Priority Data
Jun. 20, 2002 (GB) 0214229.7

(51) Int. Cl. B67D 5/40

(52) U.S. Cl. 222/383.1; 222/92; 222/206

(57) ABSTRACT

A hand-squeezable dispenser comprises a holder (2) of inverted-U configuration having outwardly-sprung limbs (20,21) which enclose a folded paper-card container (1) of liquid, particulate or other flowable material. A blade (23) and inside ridge (31) of one limb (20) engage, respectively, in a circumferential pocket (12) and under a circumferential shoulder (11) of the front container-wall (7). The other limb (21) is pushed in against the back container-wall (8) to engage a ridge (32) under the shoulder (11) and allow a slide (26) to be slid down into the pocket (12). A finger (25) of the slide (26) obstructs closure of a lid (24) until the pocket (12) is engaged by the slide (26), closure of the lid (24) piercing the container seal (14) with a projecting tube (34) of a sealing cap (33) on the underside of the lid (24). Dispensing is effected by opening the lid (24) and squeezing the limbs (20,21) inwardly, the container (1) recovering its shape afterwards under the outward springing of the limbs (20,21). Instead, dispensing may be by hand-operated pump (40), or by opening a slide (53) across an outlet (54) of the inverted dispenser (50).

This invention relates to dispensers and is particularly, though not exclusively, concerned with hand-squeezable and other hand-actuable dispensers.

Hand-squeezable dispensers are widely used especially for dispensing viscous or semi-viscous liquids, such as shampoos and detergents, but are also used for dispensing powders or other particulates, as well as free-flowing liquids. Dispensers of this and other hand-actuable forms commonly involve a bottle or other container of blow-moulded plastics material, that is discarded when empty. Since the bottle or other container is often specially configured for aesthetic and tactile appeal, it may represent a significant proportion of the overall cost of the product, so that economic and material wastage is involved together with environmental issues in its disposal. Although in some instances, provision is made for re-filling the bottle or other container this is normally from another plastics container that is discarded after use, so that wastage and environmental issues still to some extent remain.

It is an object of the present invention to provide a form of dispenser by which economic and material wastage and problem of environmental disposal, can be reduced.

According to one aspect of the present invention there is provided a dispenser comprising a container for liquid or other material to be dispensed, the container being of a collapsible form, and a holder for at least partially enclosing the container, wherein the holder has a resiliently-biased part for engagement with the container for resisting collapse of the container.

The dispenser of the invention is of especial application in those circumstances where dispensing is to be from the container from time to time (that is to say, where it is not intended to empty the full contents on first opening), and where the container does not have any inherent resilience resisting collapse. In this latter regard, the container may be of material (for example, paper, paperboard or card, or metal-foil or plastics-film) that is relatively inexpensive and readily bio-degradable so that the economic and other disadvantages of using resilient plastics can be avoided. Moreover, the material used may be thinner than would normally be expected since before the container is inserted in the dispenser and opened, shape and strength of the container may be maintained by pressure of the contents within. Furthermore, the aesthetic and tactile appeal desired, can be more cost-effectively invested in the re-useable holder rather than in the disposable bottle- or other container-dispenser of the prior art.

The resiliently-biased part of the dispenser of the invention may project into a part of the container to engage the container as aforesaid, and may comprise a limb of the holder having a slide that is operable selectively for extension and retraction from the engagement. The limb may be one of two resiliently-biased limbs of the holder which extend either side of the container, and which may both engage the container as aforesaid. The limb or limbs may each engage in a respective pocket-part of the container.

The container may have an external shoulder, and in these circumstances the holder may have one or more projections for abutment with the shoulder in retaining the container within the holder. Dispensing from the container may be effected simply by gravity from an outlet of the container or by squeezing the dispenser by hand, or it may be by operation of a hand-operated or other pump mounted on the holder.

According to a feature of the present invention a hand-squeezable dispenser comprises a container for liquid or other material to be dispensed, the container being compressible for dispensing the liquid or other material therefrom, and a holder for at least partially enclosing a compressible or otherwise collapsible container of liquid or other dispensable material, wherein the holder has a resiliently-biased part which is squeezable by hand onto the container against the resilient bias for compressing the container from its uncompressed condition, and which is for engagement with the container to return the container towards its uncompressed condition under the action of the resilient bias when squeezing is relaxed.

In accordance with another aspect of the invention, there is provided a holder for combination with a compressible or otherwise collapsible container of liquid or other dispensable material in providing a dispenser of such material with the container at least partially enclosed by the holder, wherein the holder has a resiliently-biased part that is engageable with the container for resisting collapse of the container.

The resiliently-biased part of the holder may comprise a limb having a slide that is operable selectively for extension or retraction from it. The limb may be one of two limbs for straddling and engaging the container, and in these circumstances the two limbs may be splayed out resiliently from one another from an interconnecting top-section of the holder, so that the holder is substantially of a U-configuration.

Three dispensers in accordance with the invention will now be described, by way of example, with reference to the accompanying drawings, in which:

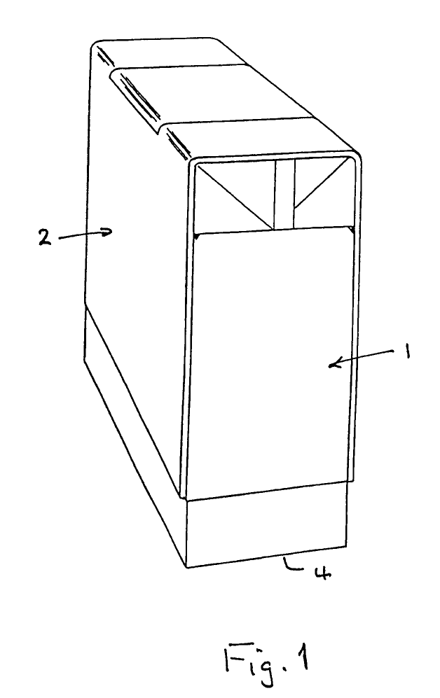

FIG. 1 is a perspective view of a first, hand-squeezable dispenser according to the present invention;

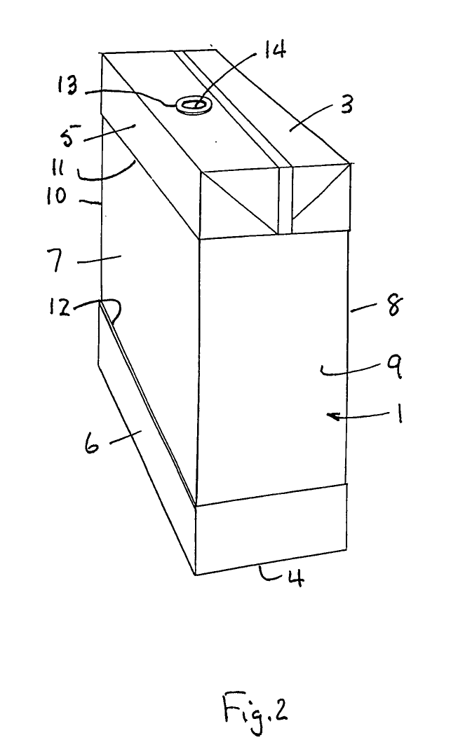

FIG. 2 is a perspective view of a container of viscous or semi-viscous liquid, forming part of the hand-squeezable dispenser of FIG. 1;

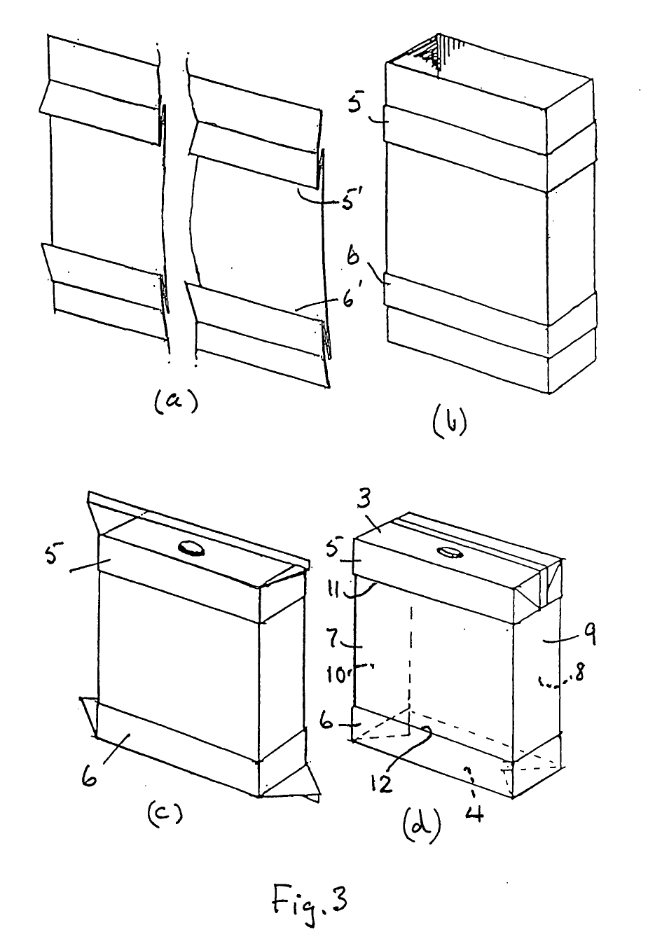

FIG. 3 is illustrative at (a) to (d) of successive folding steps in the construction of the container of FIG. 2;

FIG. 4 is a perspective view of a frame or holder for receiving the container of FIG. 2, in the assembled hand-squeezable dispenser of FIG. 1;

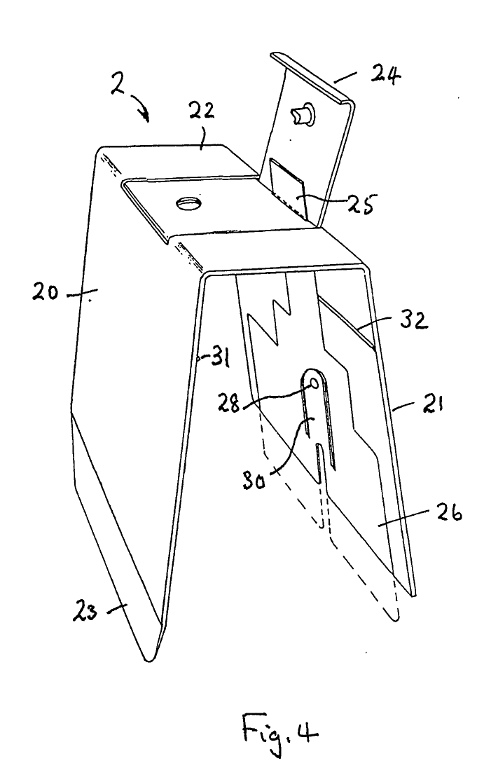

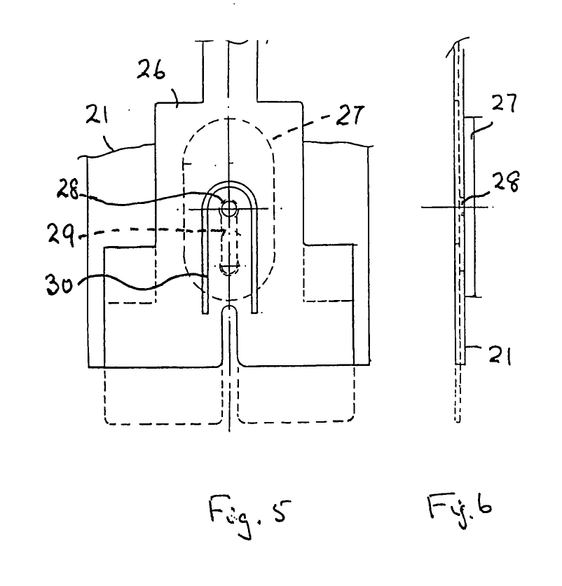

FIGS. 5 and 6 are, respectively, front and side elevations showing detail of a lower part of one of two limbs of the holder of FIG. 4;

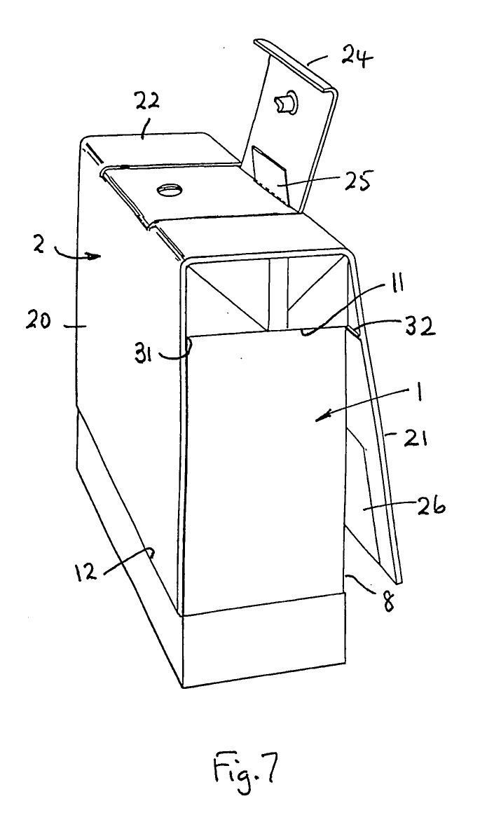

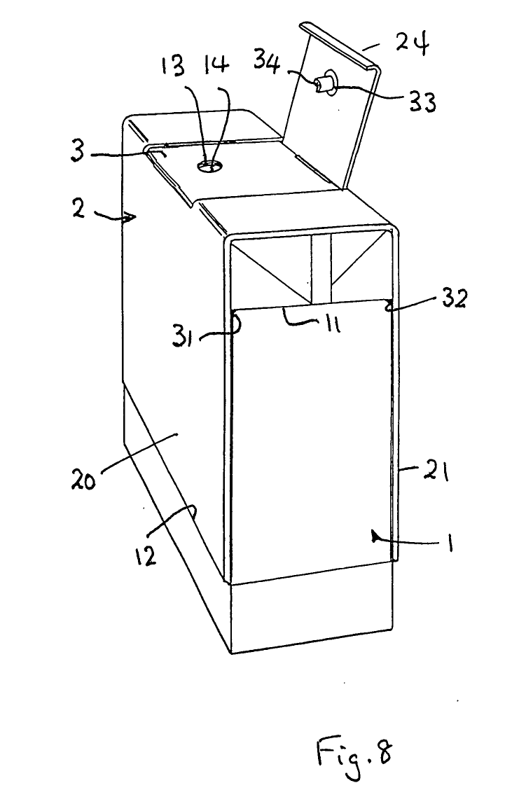

FIGS. 7 and 8 are perspective views illustrating successive stages of assembly of the hand-squeezable dispenser of FIG. 1;

FIG. 9 is a perspective view of a second hand-actuable dispenser according to the invention;

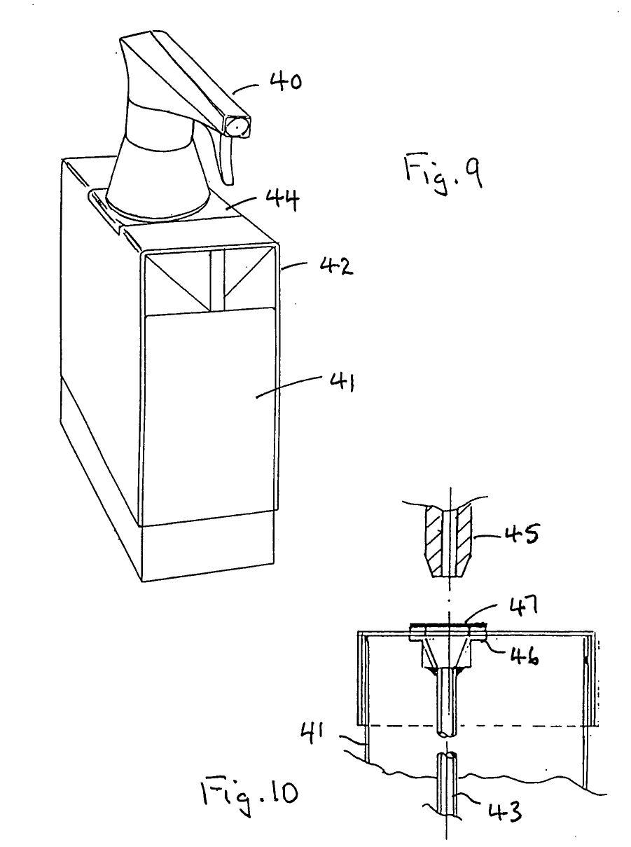

FIG. 10 is a sectional view of part of the dispenser of FIG. 9;

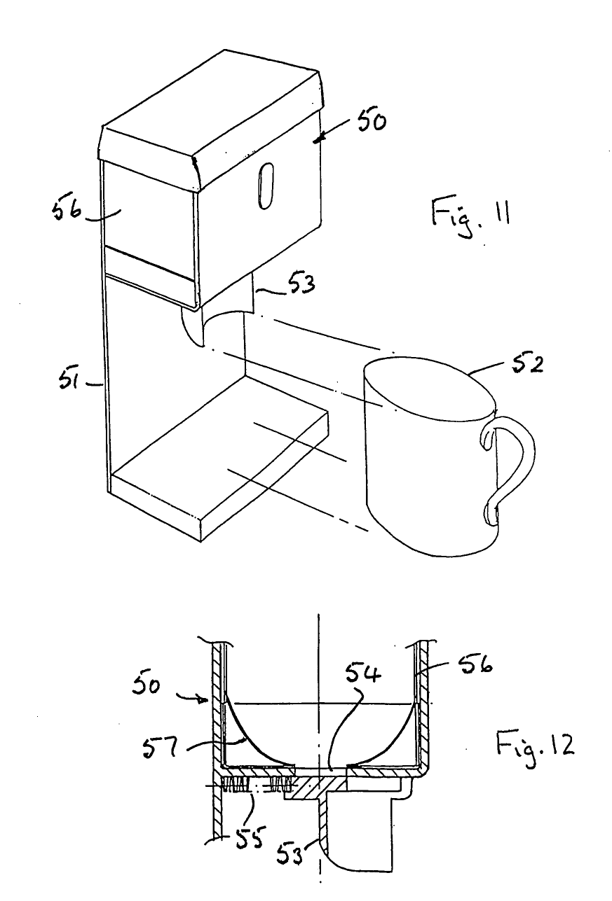

FIG. 11 is a perspective view of the third dispenser according to the invention; and

FIG. 12 is a sectional view of part of the dispenser of FIG. 11.

Referring to FIG. 1, the hand-squeezable dispenser is for dispensing a viscous or semi-viscous liquid such as a detergent, and consists of a rectangular compressible container 1 holding the liquid, and a moulded-plastics frame or holder 2 having an inverted-U configuration, for partially enclosing the container 1.

The container 1, which is illustrated in FIG. 2, is of a folded-paper or -card box-construction having an internal wax-coating or liquid-proof membrane for retaining the liquid to be dispensed; where a membrane is used it may be of plastics- or metal-film bonded as a backing to the paper or card. The folding of the paper or card is carried out in successive steps (a) to (d) illustrated in FIG. 3, to define the top and bottom walls 3 and 4 of the container 1 as extending from upper and lower circumferential double-fold sections 5 and 6 respectively, that both overlap the front and back walls 7 and 8 and the two side walls 9 and 10 of the container 1. As illustrated at (a) of FIG. 3, folding starts with establishing double folds 5′ and 6′ in the paper or card sheet, and bonds are made (by glue or otherwise) within both folds of the double fold 5′ so that the resulting double-fold section 5 of the completed container 1 establishes a firm, circumferential shoulder 11 at the upper end. No such bonds are formed within the folds of the double fold 6′ (or at least within the inner fold) so that an upwardly-open circumferential pocket 12 is established in the resulting double-fold section 6 at the lower end. A ring 13 that defines an outlet for the liquid is inset off-centre (it could be centrally) into the top wall 3; the outlet remains closed by a membrane seal 14 that extends across the ring 13, until the container 1 is activated for use within the holder 2.

Referring now also to FIG. 4, the holder 2 has two flat-plate limbs 20 and 21 that splay out resiliently from an interconnecting top-section 22;
the limb 20 is longer than the limb 21 by virtue of an extra, bottom blade-section 23 of reduced thickness. The top-section 22 has a transverse cap or lid 24 which is hinged resiliently to the limb 21 and is held open by a finger 25 that projects from a retracted slide 26 mounted in a dove-tailed groove on the inside of the limb 21.

As illustrated in more detail in FIGS. 5 and 6, the slide 26 is coupled to a locking button 27 on the outside of the limb 21, by a pin 28 that extends through a vertical slot 29 in the limb 21. With the button 27 in the position shown in FIG. 5, the pin 28 is at the top of its slot 29 for retraction of the slide 26 and with the finger 25, as shown in FIG. 4 obstructing closure of the lid 24. Movement of the button 27 downwardly to take the pin 28 to the bottom of its slot 29, extends the slide 26 to project from the bottom of the limb 21 as illustrated in dashed line in FIGS. 4 to 6, and withdraws the finger 25 from obstructing the lid 24.

The slot 29 is wider at its top and bottom than elsewhere along its length, and the pin 28, which is fixed to a resilient finger 30 of the slide 26, has a diameter adjacent the finger 30 that enables it to occupy the top or bottom of the slot 29 but is too large for it to move between them. The diameter of the pin 28, however, steps down away from the finger 30 to an extent that allows the pin 28 to move from top to bottom along the slot 29 when the button 27 is depressed to displace the pin 28 axially against the spring bias of the finger 30. Thus, the slide 26 is held locked in its fully-extended or -retracted condition until the button 27 is depressed to release the pin 28 for sliding along the slot 29.

Assembly of the dispenser is carried out by placing the holder 2 with its limbs 20 and 21 straddling the upper end of the container 1 and extending down alongside the front and back walls 7 and 8 respectively. The holder 2 is angled to insert the blade-section 23 of the limb 20 in the pocket 12 on the wall 7. It is then pushed down fully to bring the top-section 22 flat onto the top wall 3 of the container 1, and a ridge-projection 31 on the inside of the limb 20, under the shoulder 11 of the front container-wall 7. This brings about the intermediate state of assembly of the dispenser illustrated in FIG. 7, in which the limb 21 remains splayed out resiliently from the back wall 8 of the container 1.

In order to complete assembly of the dispenser, the limb 21 is pushed in towards the back wall 8 and held there by hand, to bring a ridge-projection 32 on the inside of the limb 21 under the shoulder 11 of the wall 8. With the limb 21 held in this condition, the button 27 is depressed and then pushed down to extend the slide 26 into the pocket 12 on that wall. This allows the hand-hold on the limb 21 to be released, and withdraws the finger 25 from obstructing closing of the lid 24, so as to bring about the fully-assembled state of the dispenser, illustrated in FIG. 8. In this state, the engagement of the blade-section 23 and the extended slide 26 within the pocket 12, and the projections 31 and 32 under the shoulder 11, retains the container 1 front and back, firmly within, and as one with, the holder 2. The slide 26 locks in its extended condition with the pin 28 at the bottom of the slot 29 for positive retention of the container 1 within the holder 2.

In order to activate the dispenser from the state illustrated in FIG. 8, ready for dispensing liquid, the lid 24 is closed down onto the top wall 3 of the container 1; the resilience of its hinging gives the lid 24 a snap action in opening and closing. Closing of the lid 24 brings a sealing cap 33 on the underside of the lid 24 down hard onto the ring 13. A piercing tube 34 of the cap 33 pierces the seal 14, but the cap 33 fits closely onto the ring 13 so that the container 1 remains sealed while the lid 24 is closed.

Liquid within the container 1 is dispensed by first snapping the lid 24 open so as to unstop the outlet defined by the ring 13, and then squeezing the limbs 20 and 21 inwardly towards one another while the dispenser is held appropriately inverted. The squeezing of the limbs 20 and 21 inwardly towards one another, applies pressure to the walls 7 and 8 of the container 1 forcing liquid from within the container 1 through the outlet-ring 13. When sufficient liquid has been dispensed, the squeezing action is relaxed, allowing the limbs 20 and 21 to return under the resilient action of their hinging to the top-section 22.

The folded-paper or -card construction of the container 1 is such that until it is assembled with the holder 2, it keeps its rectangular form sufficiently to allow it to stand unsupported upright on its bottom wall 4, only while it is full and in its initial, sealed state. Once the seal 14 has been pierced and the container 1 squeezed to dispense liquid, the container 1 on its own tends to collapse, but when assembled with the holder 2 in accordance with the invention, it is afforded rigidity and is restored after squeezing, to the original rectangular form. In the latter respect, the insertion of the blade-section 23 and extended slide 26 in the pocket 12, ensures that the walls 7 and 8 of the container 1 are pulled outwardly, to restore the container 1 to its original shape and to hold it so, as the limbs 20 and 21 move outwardly when the squeezing is relaxed. Once the container 1 has been restored to its original form, the lid 24 is closed, to seal the container 1, until the dispenser is required to be used again.

The dispenser can be used repeatedly in the manner described until the container 1 is empty. A refill container of the same construction and initially-sealed form as container 1, is then loaded in the holder 2 in place of the container 1. The empty container 1 is released from the holder 2 by first opening the lid 24, and retracting the slide 26 from the pocket 12 by depressing the button 27 and lifting it to move the pin 28 to the top of the slot 29. Retraction of the slide 26 moves the finger 25 upwardly to preclude closing of the lid 24, and frees the limb 21 to splay outwardly away from the back wall 8, returning the dispenser to the intermediate state illustrated in FIG. 7. The splaying outwardly of the limb 21 releases the projection 32 from under the shoulder 11 so that the container 1 can be withdrawn from between the limbs 20 and 21, disengaging the projection 31 from the shoulder 11 and the blade-section 23 from the pocket 12. The empty container 1 can now be withdrawn from the holder 2 after disengaging the shoulder 11 from the ridge-projection 30; a spring-release may be incorporated in the holder 2 to aid this disengagement and withdrawal.

The refill container, and any subsequent container used for refill purposes, is assembled with the holder 2 and used for dispensing, in the same way as the container 1 is assembled and used with it as described above. In each case, the container when loaded in the holder 2 is held firmly by engagement with it of the limbs 20 and 21, and after being squeezed to dispense liquid is returned by them to its original, uncompressed shape under the resilience of their hinging. Moreover, the holder 2 affords support to the assembly, enabling the dispenser to stand upright on its bottom wall (the wall 4 of the container 1).

The double-folds 5 and 6 of the container 1, providing respectively the shoulder 11 (for abutment with the ridge-projections 30 and 31) and the pocket 12 (for receiving the blade-section 23 and the slide 26), have advantage for retention of the container within the holder 2, but also have advantage in strengthening the top and bottom corners of the container 1. A shoulder and pocket corresponding to the shoulder 11 and pocket 12 may, however, be formed, possibly with corresponding strengthening effect, otherwise than as described above. For example, where the container is to be manufactured from a laminate (perhaps with an outer of paper or card and a protective inner), appropriate folds may be incorporated in the outer before lamination; use of the laminate may allow normal carton-manufacturing machinery to be utilised in manufacture.

With the normal carton-manufacturing and sealing technique there is (as with the described container 1 folded as illustrated in FIG. 3) a folded-over triangular fold at each end of the carton. This has especial advantage at the top of the container 1 in giving added bulk and rigidity to the double-fold section 5 that further resists disengagement of the shoulder 11 from abutment with the ridge-projections 30 and 31. However, as an alternative to using the added double folds to form the shoulder 11 and the pocket 12, they may be provided simply by caps that are attached (by glue or otherwise) to a standard carton produced by normal manufacturing techniques.

The slide 26 of the dispenser described above, is mounted within a groove on the inside of the limb 21, but although it is in this way recessed into the limb 21, contact between it and the back wall 8 of the container 1 occurs, especially when the button 27 is depressed to extend or retract the slide 26. Such contact may be found of disadvantage, in particular in restricting movement of the slide 26, and in these circumstances the holder 2 may be modified to overcome the problem by enclosing the slide 26 within its groove in the limb 21.

It is not necessary for engagement between the blade-section 23 and the slide 26 of the holder 2 to be with a pocket such as the pocket 12 of the container 1 described above. For example, the blade-section 23 and the slide 26 may engage under strap elements attached (by glue or otherwise) to the walls 7 and 8 respectively of the container 1. Also, the blade-section 23 and/or the slide 26 instead of extending throughout the full widths of the front and back walls 7 and 8, may be slotted vertically (as shown in FIGS. 4 and 5) so as to provide a plurality of component fingers for engaging in the pocket 12. The pocket 12 itself need not then be continuous throughout the full width of each wall 7 and 8, but may be divided into separate pocket-sections for receiving the fingers; division of the pocket 12 and use of a slotted slide 26 in this way, may be of particular advantage where a seam runs down the back wall 8 of the container 1.

Furthermore, although the dispenser is described in the context of dispensing viscous or semi-viscous liquid, it may be used for dispensing free-flowing liquid (for example, milk or fruit juice), powder (for example, talcum powder) or particulates (for example, granular salt). Where, for example, liquids are involved, the walls of the container may have a laminated construction as referred to above, and also in this regard, may have outer and inner layers of polyethylene on paperboard with, or without, aluminium foil interposed between the paperboard and an inner layer of polyethylene.

Although with the dispenser described above, dispensing is carried out by squeezing the container, the invention is not limited to this, but may be used where actuation is achieved otherwise. In this regard dispensing may be carried out using a hand-operable pump as illustrated in FIGS. 9 and 10.

Referring to FIG. 9, a trigger-operated spray-pump 40 in this case draws product, for example liquid polish, from a carton 41 to dispense it in spray form. The carton 41, which is retained within a holder 42 (corresponding in all respects to the holder 2 described above), is of the same construction as the container 1 described above but with the addition of a tube 43 (FIG. 10) that extends to the bottom of the carton 41, for connection to the pump 40.

More particularly in the latter respect, the pump 40 is mounted on the lid 44 of the holder 42 to connect with the tube 43 via a tapered plug 45. The plug 45, as illustrated in FIG. 10, enters the carton-outlet defined by a fitting 46 as the lid 44 is closed onto the carton 41. A seal 47 across the fitting 46 is pierced by the plug 45 on closure of the lid 44, and the plug 45 seats tightly within the fitting 46 to establish an air-tight connection between the pump 40 and the tube 43.

A further example of use of the dispenser for dispensing coffee or other granules, is illustrated by FIGS. 11 and 12 and will now be described.

Referring to FIGS. 11 and 12, the dispenser 50 is in this example mounted upside-down within a stand 51 for dispensing coffee or other granules. The dispenser 50 is actuated to dispense the granules in response to presentation of a cup 52 to the stand 51. More particularly, the cup 52 is presented to bear on a slide 53 that blocks the outlet opening 54 of the dispenser 50. Pressure of the cup 52 on the slide 53 deflects the slide 53 rearwardly against the action of a spring 55 to unblock the opening 54 and allow coffee granules to fall from the dispenser 50 into the cup 52; free-flow of the granules from the dispenser 50, and eventual total-emptying of its container 56, is facilitated by a funnelling insert 57 within the container 56. Release of the pressure by withdrawal of the cup 52, allows the slide 53 to return under the action of the spring 55 to block the opening 54 once again and terminate the flow of granules.

1-21. (canceled)

21. A dispenser comprising a collapsible container for material to be dispensed in a dispensing operation of the dispenser, the container having an uncollapsed condition before the dispensing operation and a partially collapsed condition during the dispensing operation, and a holder for at least partially enclosing the container, wherein the holder includes a resiliently-biased part for engagement with the container to resist collapse of the container, the resiliently-biased part acting via the engagement with the container when the container is partially collapsed during the dispensing operation to return the container to the uncollapsed condition.

22. The dispenser according to claim 21, wherein the container has an opening therein, and the resiliently-biased part projects into the opening for engagement with the container as aforesaid.

23. The dispenser according to claim 21, wherein the container has an external shoulder, and the holder has one or more projections for abutment with the shoulder in retaining the container within the holder.

24. The dispenser according to claim 21, wherein the holder carries a hand-operable pump for drawing off the material contained by the container.

25. A hand-squeezable dispenser comprising a compressible container for material to be dispensed, the container having an uncompressed condition and being compressible from the uncompressed condition for dispensing the material therefrom, and a holder for at least partially enclosing the compressible container, wherein the holder includes a hand-squeezable part having a resilient bias for opposing squeezing by hand, the hand-squeezable part in response to the squeezing by hand compressing the container from its uncompressed condition in opposition to the resilient bias, and the hand-squeezable part engages with the container to return the container towards its uncompressed condition under the action of the resilient bias when the squeezing by hand is relaxed.

26. The dispenser according to claim 25, wherein the container has an external pocket-part, and the resiliently-biased part extends into the pocket-part for engagement with the container as aforesaid.

27. The dispenser according to claim 25, wherein the holder includes a resiliently-biased limb, and the limb has a slide that is operable selectively for extension into or retraction from engagement as aforesaid with the container.

28. The dispenser according to claim 27 wherein the limb is one of two resiliently-biased limbs of the holder which extend either side of the container.

29. The dispenser according to claim 28, wherein both limbs engage the container as aforesaid.

30. The dispenser according to claim 29, wherein both limbs engage in respective pocket-parts of the container.

31. The dispenser according to claim 28, wherein each limb has a ridge-projection for abutment with a respective shoulder-part of the container in retaining the container within the holder.

32. The dispenser according to claim 21, wherein the container has a dispensing outlet for the material, and the holder includes a movable member that is selectively movable between a first condition in which it is clear of the dispensing outlet of the container and a second condition in which it is engaged with the dispensing outlet of the container, and wherein the dispenser includes an interlock between the resiliently-biased part and the movable member to preclude movement of the movable member into its second condition while the resiliently-biased part is disengaged from engagement as aforesaid with the container.

33. The dispenser according to claim 32, wherein the engagement of the movable member with the outlet is such that the outlet is closed while the movable member is in its second condition.

34. A holder for combination with a compressible or otherwise collapsible container of liquid or other dispensable material in providing a dispenser of such material, wherein the holder comprises a body for at least partially enclosing the container inserted therein, and the body has a part which is for engagement with the container and which is resiliently biased to act via this engagement to resist collapse of the container and thereby to the extent the container collapses during dispensing of the liquid or other material, to return it towards its uncollapsed condition.

35. The holder according to claim 34, wherein the resiliently-biased part comprises a limb of the holder having a slide that is operable selectively for extension or retraction from the limb.

36. The holder according to claim 35, wherein the limb is one of two limbs for straddling and engaging the container.

37. The holder according to claim 36, wherein the holder includes a top-section interconnecting the two limbs, and the two limbs are splayed out resiliently from one another either side of the top-section.

38. The holder according to claim 37, wherein the top-section has an aperture therein, and a lid for covering the aperture, the lid being selectively movable between an open condition in which it is clear of the aperture and a closed condition in which it covers the aperture, and wherein an interlock between the slide and the lid precludes movement of the lid into its closed condition while the slide is retracted.

39. The holder according to claim 37, wherein each limb has a ridge-projection located between the limbs adjacent the top-section.

40. The holder according to claim 36, wherein the limbs are substantially-flat plates.
